(19) United States
(12) Patent Application Publication
(10) Pub. No.: US 2016/0065910 A1
(43) Pub. Date: Mar. 3, 2016

(54) VIDEO GATEWAY DEVICE

(71) Applicant: Fiber Group S.A., Poznan (PL)

(72) Inventor: Maciej Fiedler, Poznan (PL)

(21) Appl. No.: 14/845,087

(22) Filed: Sep. 3, 2015

Related U.S. Application Data
(60) Provisional application No. 62/045,518, filed on Sep. 3, 2014.

(30) Foreign Application Priority Data
Apr. 20, 2015 (EP) 15461527

(51) Int. Cl. H04N 7/18; H04L 12/28; H04L 12/24; H04N 5/77; H04N 5/232

(52) U.S. Cl. CPC H04N 7/186; H04N 5/772; H04N 5/23216; H04L 41/22; H04L 12/2803

(57) ABSTRACT

A programmable video gateway device for use with a gateway and a home network manager having a plurality of associated network elements. The device may comprise a plurality of user-programmable functions. The device may also comprise a processor to control the plurality of user-programmable functions, a camera module controllable to record an image via at least one of the home network manager and the processor, and/or an interface to receive at least one of a plurality entry requests, and enable a user to program the plurality of user-programmable functions to respond to the received entry requests via the processor.

The patent application makes reference to, claims priority to and claims benefit from U.S. Provisional Patent Application Ser. No. 62/045,518 entitled “Video Gateway Device” filed on Sep. 3, 2014, and to European Patent Application No. 15461527 entitled “An Intercom Device” filed on Apr. 20, 2015, both of which are hereby incorporated herein by reference in their entirety.

### TECHNICAL FIELD

Aspects of the present disclosure relate to electronic systems and/or networking. More specifically, certain implementations of the present disclosure relate to a video gateway device.

### BACKGROUND

Existing methods and systems for providing security monitoring or control can be costly, cumbersome and inefficient. Further limitations and disadvantages of conventional and traditional approaches will become apparent to one of skill in the art, through comparison of such approaches with some aspects of the present method and apparatus set forth in the remainder of this disclosure with reference to the drawings.

### BRIEF SUMMARY

A system and/or method is provided for an video gateway device, substantially as shown in and/or described in connection with at least one of the figures, as set forth more completely in the disclosure and/or the claims.

These and other advantages, aspects and novel features of the present disclosure, as well as details of illustrated implementation(s) thereof, will be more fully understood from the following description and drawings.

### BRIEF DESCRIPTION OF SEVERAL VIEWS OF THE DRAWINGS

FIG. 1 illustrates an example home network.

FIG. 2 illustrates an example programmable video gateway scene.

FIG. 3 illustrates a second example programmable video gateway scene.

FIG. 4 illustrates an example video gateway device.

FIG. 5 illustrates example operation of a video gateway device with an example home network.

FIG. 6 illustrates an example flow chart of a method for an example process of operation of a video gateway device.

### DETAILED DESCRIPTION

Certain implementations may be found in a method and system for a video gateway device. In one embodiment, a gateway device may be installed at a gateway, wherein the gateway may be configurable to perform a plurality of user-programmable functions, and may be activated via a home network manager having one or more associated network elements. The gateway device may have a processor that may control one or more of user-programmable actions, a camera module that may be controllable to record an image, and/or a device interface that may receive one or more entry requests. The gateway device may be enabled via the device interface to receive one or more of the one or more of user-programmable actions to respond to one or more of the received entry requests. The camera module may record an image. One of the one or more entry requests may be received at the gateway device. One or more of the one or more of user-programmable actions based on one or more of the received entry requests may be determined. The gateway device may comprise an antenna that may communicate one or more of the one or more entry requests to one of the home network manager and the associated network elements. The device interface may comprise a plurality of light emitting diodes (LEDs). At least one of the LEDs may illuminate in different colors in response to different received entry requests. The gateway device may have a communication module for communicating one or more of the one or more received entry requests to one of the home network manager and the plurality of associated network elements.

In another embodiment, a programmable video gateway device may be used with a gateway and a home network manager having a plurality of associated network elements. The gateway may have a plurality of user-programmable actions. The device may comprise a processor, a camera module and/or an interface. The processor may be configurable to control the plurality of user-programmable actions. The camera module may be configurable to be controllable to capture an image, wherein the camera module may be configurable to be controlled via at least one of the home network manager and the processor. The interface may be configurable to receive one or more entry requests, wherein the interface may be configurable to receive commands from a user to program one or more of the plurality of user-programmable actions to respond to the received one or more entry requests via the processor. A programmable video gateway device may comprise an antenna that may be configurable to communicate one or more of the plurality of user-programmable actions to one of the home network manager and the associated network elements. The interface may comprise a plurality of light emitting diodes (LEDs). One or more of the LEDs may be configurable to illuminate in a pre-defined color in response to one or more of the received entry requests, wherein the pre-defined color is different for as between at least two of the received entry requests. The plurality of user-programmable actions may include one or more actions configurable to be activated at one or more of the associated network elements. A programmable video gateway device may comprise a communication module that may be configured to communicate one or more of the received entry requests to one of the home network manager and the plurality of associated network elements. In one embodiment, when the interface receives a correct entry request, at least one of the home network manager and/or the processor may be further configured to activate one of the plurality of user-programmable actions via at least one of the gateway and the programmable video gateway device.

In another embodiment, a programmable video gateway system may comprise a plurality of associated network elements including a gateway device and a gateway having a plurality of user-programmable functions. The gateway device may have a processor that may control the plurality of user-programmable functions, a camera module that may be controllable to record an image, and/or a device interface that may receive one or more entry requests, home network manager that may have a manager interface configured to enable a user to program the plurality of user-programmable functions to respond to one or more of the received entry requests via the processor. The gateway device may have an antenna that may be configurable to communicate one or more of the one or more entry requests to one of the home network manager and the associated network elements. The device interface may comprise a plurality of light emitting diodes (LEDs). One or more of the plurality of LEDs may be configurable to illuminate in a pre-defined color in response to one or more of the received entry requests, wherein the pre-defined color may be different for as between at least two of the received entry requests. The plurality of user-programmable functions may include actions activable at one or more of the associated network elements. The plurality of use-programmable functions may include opening the gateway. The gateway device may have a communication module that may be configured to communicate the received entry requests to at least one of the home network manager and the plurality of associated network elements. The gateway device may be configured to receive a correct entry request, at least one of the home network manager and the processor configured to activate one of the plurality of user-programmable functions of the gateway.

As utilized herein the terms “circuits” and “circuitry” refer to physical electronic components (i.e. hardware) and any software and/or firmware (“code”) which may configure the hardware, be executed by the hardware, and/or otherwise be associated with the hardware. As used herein, for example, a particular processor and memory may comprise a first “circuit” when executing a first plurality of lines of code and may comprise a second “circuit” when executing a second plurality of lines of code. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and/or “module” refer to functions than may be performed by one or more circuits. As utilized herein, the term “example” means serving as a non-limiting example, instance, or illustration. As utilized herein, the terms “for example” and “e.g.” introduce a list of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled, or not enabled, by some user-configurable setting.

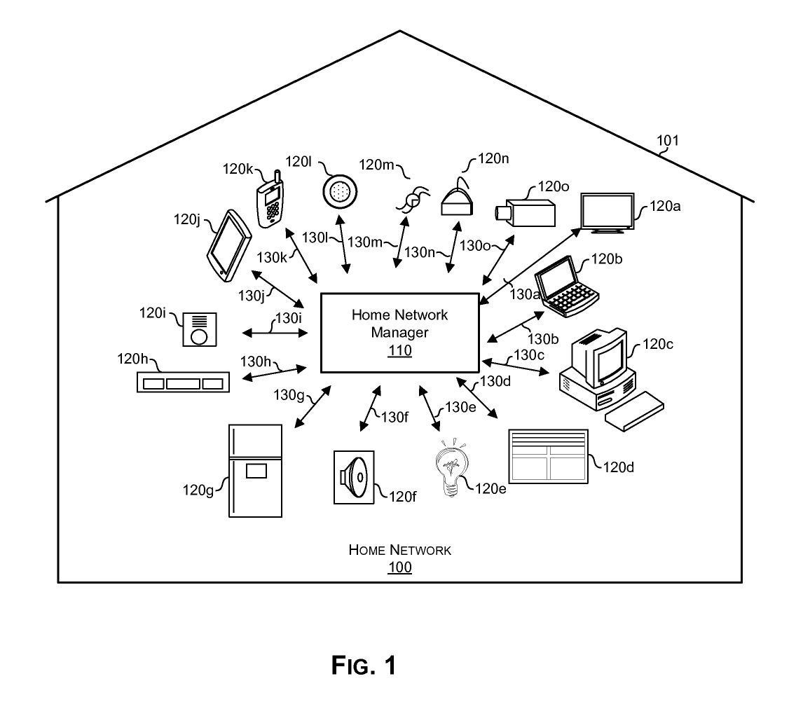

FIG. 1 illustrates an example home network. Referring to FIG. 1, there is shown a home network 100.

The home network 100 may correspond to a location 101. The location 101 may, for example, correspond to a residence (e.g., home, apartment) or non-residence premises (e.g., small business, school, library, factory, or the like). In this regard, the home network 100 may, for example, comprise a plurality of home network elements, such as, for example, a plurality of home network elements 120a-120o. The home network elements (e.g., home network elements 120a-120o) may, for example, comprise one or more devices, systems, fixtures, appliances, and/or other circuitry. The home network elements (e.g., home network elements 120a-120o) may comprise, for example, one or more televisions 120a, one or more computers (e.g., laptop computer 120b, desktop computer 120c), one or more personal and/or handheld devices (e.g., tablet 120j, mobile phone 120k, smart watch 120m), one or more multimedia devices and/or components (e.g., speakers 120f), one or more structural fixtures (e.g., windows/window blinds 120d, smart watch), one or more lighting and/or electrical fixtures 120e, one or more appliances (e.g., refrigerator 120g), one or more environmental sensory devices 120h (e.g., thermometers, humidity meters), and/or one or more security devices 120i (e.g., a smoke detector, a carbon monoxide detector, a security alarm, a motion detector) one or more sensors and/or controller (e.g., intelligent motion sensor 120l, RGBW controller 120n) and/or other devices (e.g., video gateway device 120o).

The disclosure is not limited to any particular type of a home network. Furthermore, the disclosure is not limited to any particular combination of home network elements. It is to be understood that although the network is referred to as a “home network” throughout the disclosure, the disclosure is not limited in this way. Specifically, the network may comprise any other network that may be operable to control one or more network elements. For example, the network of the disclosure (whether or not referred to as a “home network”) may be implemented in a residential, non-residential, commercial, industrial and/or any other setting. Similarly, the network elements may comprise network elements (whether or not referred to as a “home network elements”) implemented in a residential, non-residential, commercial, industrial and/or any other setting.

In some instances, the home network 100 may incorporate a home network manager 110. The home network manager 110 may comprise suitable circuitry, interfaces, logic, and/or code for implementing various aspects of the present disclosure. For example, the home network manager 110 may be configured for use in managing, servicing, and/or interacting with one or more home network elements. Although the home network manager 110 is shown in FIG. 1 as a single and separate device, the disclosure is not limited in this way. For example, in some implementations, one or more functions of the home network manager 110 may be provided by one or more home network elements (e.g., providing user interface via tablet 120j and/or television 120a). In an example embodiment of the disclosure, the home network manager 110 may be implemented as a virtual platform, such as, for example, one or more software modules may run on, and/or utilize resources of one or more home network elements (e.g., laptop 120b, desktop 120c).

The home network manager 110 may be configured to communicate with one or more elements (e.g., home network devices, home network elements) in a home network. In an example embodiment of the disclosure, the home network manager 110 may be operable to communicate with one or more devices and/or systems that may be external to a home network, using, for example, optical, wired and/or wireless communication links.

Although the home network manager 110 is illustrated as a single device, the disclosure is not limited in this way. For example, the home network manager may comprise one or more home network manager that may each interact with one or more home network elements (e.g., home network elements 120a-120o). In an example embodiment of the disclosure, each of the one or more home network managers may be associated with particular one or more home network elements. In another example, one or more of the one or more home network managers may be associated with any one or more home network elements (e.g., home network elements within range of a particular home network manager, with best communication path).

In an example embodiment of the disclosure, the home network manager 110 may be implemented in an integrated or a distributed system. An integrated system may be implemented, for example, on one computer, server, machine or device, where the integrated system may be configured to perform some or all of the functions, features and/or operations of the home network manager 110 as described herein. A distributed system may be implemented with multiple components (e.g., computers, servers, machines and/or devices), where each of the multiple components may be configured to perform some or all of the functions, features and/or operations of the home network manager 110 as described herein. Each function, feature and/or operation may be implemented on one or more of the components of the distributed system. For example, a specific feature, function and/or operation may be implemented only one component of the distributed system or it may be implemented across multiple components of the distributed system.

In an example embodiment of the disclosure, in addition to or instead of the use of one or more home network managers, the home network 100 may comprise one or more master controllers for controlling one or more home network elements. A master controller may be pre-programmed and/or programmable to control one or more home network elements. A master controller may comprise, for example, a remote controller.

Although the disclosure may refer to a single home network manager, it is to be understood that the disclosure is not limited in this way. For example, the home network manager may comprise one or more home network managers that individually and/or in the aggregate may be implemented as integrated and/or a distributed system.

The home network manager 110 may interact with one or more of the home network elements 120a-120o via corresponding links 130a-130o, which may be supported by the home network manager 110 and/or the corresponding home network element(s). For example, the links 130a-130o may be implemented and/or configured to operate using a wireless protocol, such as, for example, a Z-wave protocol. In an example embodiment of the disclosure, the home network 100 may be implemented as Z-Wave network. However, the disclosure is not limited in this way. For example, the home network 110 may comprise one or more wired and/or wireless links and/or protocol. Wireless links and/or protocols, may comprise, for example, WPAN (e.g., Bluetooth or ZigBee), low power links (e.g., Bluetooth LE (BLE), Bluetooth Smart, iBeacon), near field communication protocols (e.g., NFC) and/or WLAN (WiFi/802.11) protocols and/or any other wireless links and/or protocols suitable for implementation consistent with the disclosure. Wired protocols and/or links may comprise, for example, Ethernet, Universal Serial Bus (USB), and/or any other wired links and/or protocols suitable for implementation consistent with the disclosure.

In an example embodiment of the disclosure, home network manager 110 may interact with one or more home network elements (e.g., home network elements) directly and/or indirectly. For example, the home network manager 110 may interact with one or more home network elements directly through a corresponding link (e.g., wireless, wired link/connection).

In another example, the home network manager 110 may interact with one or more home network elements indirectly though, for example, a converter (e.g., global cache). In this regard, the home network manager 110 that supports one or more particular network interfaces and/or other interfaces (e.g., USB) may be operable to interact with a particular network element (and/or another device) that may otherwise be incompatible with one or more of the one or more particular network and/or other interfaces supported by the home network manger 110. The interaction may be achieved though, for example, a converter and/or a translator. The converter and/or the translator may each comprise suitable logic, circuitry, interfaces, and/or code that may be operable to facilitate communication between a home network manager (e.g., the home network manger 110) and a home network element (home network elements 120a-120o).

In another example, the home network manager 110 may interact with one or more home network elements indirectly though, for example, other network elements. In this regard, the home network manager 110 may interact with one or more home network elements on, for example, a mesh network. An example mesh network (not shown) may facilitate communication (e.g., transmission of messages, signals, data frames) to and/or from the home network manager (e.g., the home network manager 110) to and/or from a particular network element where the communication may, for example, pass through one or more other network elements before reaching the particular network element and/or the home network manager.

In an example embodiment of the disclosure, the home network manager 110 may be operable to support one or more communication methods from one or more other home network devices (e.g., home network elements 120a-120o). For example, one or more home network elements may communicate with the home network manager 110 utilizing a particular wireless link and/or protocol (e.g., Z-wave) and/or a particular wired link and/or protocol (e.g., Ethernet), while one or more other home network elements may communicate with the home network manager 110 utilizing a different particular wireless link and/or protocol (e.g., WiFi) and/or a different particular wired link and/or protocol (e.g., USB).

In an example embodiment of the disclosure, the same one or more home network elements may communicate with the home network manager 110 by, for example, using one or more wired and/or wireless links and/or protocols at the same and/or at different times. For example, a particular network element may communicate with the home network manager 110 using a Z-Wave communication protocol for a particular communication and may communicate with the home network manager 110 using a WiFi communication protocol for another particular communication.

In an example embodiment of the disclosure, one or more home network elements (e.g., home network elements 120a-120o) may communicate with one or more home network elements (e.g., home network elements 120a-120o) directly. In this regard, the one or more network elements may utilize one or more communication links (e.g., wireless, wired) (not shown) and/or one or more network interfaces and/or other interfaces without directing (e.g., routing the communication thought, for example, a home network manager (e.g., the home network manger 110). For example, a home network element may be operable to detect existence of one or more other network elements (e.g., on the same and/or different network) and may initiate, send and/or receive communication to and/or from the one or more other network elements.

In an example embodiment of the disclosure, one network element may be out of range of a home network manager and may communicate with one or more other network elements to determine whether the one or more other network elements are within range of a particular (e.g., a home network manager previously within range of the one network element) and/or any network manager. The range detection and/or discovery may continue from one network element to another. For example, a particular home network element may need to communicate through more than one other home network element in order to, for example, communicate with a desired home network element and/or a desired, particular and/or any home network manager (e.g., the home network manager 110). The disclosure is not limited to a communication for a purpose of range discovery/detection. The communication may comprise any type of communication and may be used for a variety of other purposes (e.g., communicating with a different network element, communicating with a home network manager, controlling an out of range device, controlling another network element).

In an example embodiment of the disclosure, one or more home network elements (e.g., home networks elements 120a-120o) may be operable to control one or more other home network elements (e.g., home networks elements 120a-120o) with and/or without intermediary, such as, for example, a home network manager (e.g., home network manager). For example, one or more home network elements may be operable to control one or more other home network elements through an intermediary. In this regard, a particular network element may communicate with an intermediary (e.g., home network manager) in order to communicate with and/or to control another home networks element. An intermediary may comprise one or more devices (e.g., a preprogrammed and/or programmable master controller, home network manager) that may be operable to control one or more network elements. In another example, a particular network element may directly communicate with and/or to control another home networks element.

In an example embodiment of the disclosure, one or more home network elements (e.g. home network elements 120a-120o) and/or other devices that may be operable to communicate on the network (and/or an associated network as described herewith) and/or that may not be operable to communicate on the network but may otherwise be tractable (e.g., GPS, iBeacon, electronic tag), with one or more other network elements, devices and/or a network manager (e.g., home network manager 110) associated with a particular network (e.g., home network 100) (and/or an associated network as described herewith), may communicate with each other, other devices (e.g., on the same network, another network and/or otherwise connected and/or tractable) and/or the network manager, and/or may be operable to determine a precise location of a particular network element, device and/or network manager utilizing various communication protocols and/or interfaces.

For example, one or more network elements (and/or other devices operable on the network, an associated network as described herewith and/or otherwise traceable) may be operable to generate and/or receive information and/or one more signals and/or messages that may be utilized in determining a location of a particular network element, device and/or network manager. In this regard, a near field communication and/or a low power interface protocol (e.g., BLE, iBeacon) may be utilized for communication between the elements, devices and/or network managers. Furthermore, one more tags (e.g., small electronic devices) may be utilized, to facilitate location of particular elements, devices and/or network managers. For example, a network element, device and/or home network manager may generate a signal and/or a message (on the network, on an associated network and/or through a built in, external, portable and/or otherwise attachable tag) that may be received by another network element, device and/or network manager.

In an example embodiment of the disclosure, one or more home network elements, devices and/or manager may cooperate (e.g., exchange information) to, for example, collectively and/or individually determine a precise location of a particular network elements, device and/or network manager based on the received one or more signals and/or messages. As an example only, a particular network element, device and/or home network manager may generate a signal and/or a message that may be received by other network element, device and/or home network device within a particular time frame. The information about the time it took to, for example, receive the particular one or more signals and/or messages (and/or the information gather from the one or more signals and/or messages, such as, for example, signal strength) may be used to determine the precise location (e.g., distance to/from the network element, device, network manager that received the particular one or more signals and/or message) of the particular network element, device and/or network manager.

In operation, the home network manager 110 may be operable to manage a home network (e.g., the home network 100). The home network manager 110 may be utilized, for example, as an interface platform for interacting with various network elements (e.g., the home network elements 120a-120o). In this regard, the home network manager 110 may support establishing and/or configuring one or more communication connections/links (e.g., the links 130a-130o) with the one or more elements of the home network 110. Once established, the connectivity between the home network manager 110 and the home network elements (e.g., network elements 120a-120o) may, for example, be utilized to enable centralized monitoring, control, and/or management of the home network elements, and/or of the home network 100 as a whole. For example, the home network manager 110 may be operable to control operations of certain elements (e.g., turn on television 120a, switch to particular channel(s) at particular days/times, and/or record if recording is supported); monitor environment in the home network, such as by obtaining environmental readings (e.g., temperature, humidity, etc.) via example environmental sensory devices 120h, and may process these readings (e.g., to determine if/when to adjust other home network elements accordingly); adjust one or more example lighting and/or electrical fixtures 120e (e.g., turn lights on or off); lower/raise example window blinds 120d; adjust operations of example appliances (e.g., refrigerator 120g), such as, for example, based on a preconfigured power efficiency/optimization profile; monitor for any indications of a security/safety problem, based on, for example, input from example security devices 120i, and/or act accordingly (e.g., send notifications to users, such as by texting example smartphone 120k, and/or automatically notify authorities, e.g., by dialing ‘911’ and/or contacting preconfigured emergency numbers).

In an example embodiment of the disclosure, the home network manager 110 may provide and/or utilize user interface services in the home network. In this regard, the home network manager 110 may be operable to support use of user interface functions, and/or to generate and/or store information corresponding thereto, which may be utilized to enable interactions between the home network manager 110 and users (e.g., in the home network 100). For example, in some implementations, the home network manager 110 may be configured to generate and/or use a graphic user interface (GUI), for visually displaying information and/or providing interactivity with users (e.g., for providing input thereby). One or more user interfaces may enable configuring the home network manager 110 and/or functions provided by the home network manager 110. In an example embodiment of the disclosure, the one or more user interfaces may enable user interaction with, configuring and/or adjusting other elements in the home network 100 (e.g., elements connected to the home network manager 110).

In an example embodiment of the disclosure, the user interfaces may be provided via one or more other devices that may be communicatively coupled to the home network manager 110. For example, a GUI generated and/or used by the home network manager 110 may be displayed using existing home network elements, such as, for example, television 120a, laptop 120b, tablet 120j, and/or smartphone 120k.

The disclosure is not limited to a single network (e.g., home network 100) and/or a single network manager (e.g., home network manager 110). For example, one or more networks (e.g., home network 100) and/or one or more network managers (e.g., home network manager 110) may be grouped together. The grouping may correspond to one or more locations (e.g., location 101).

In an example embodiment of the disclosure, a network (e.g., home network 100) may be associated with one or more network managers (e.g., home network manager 110). For example, one network manager may be associated with one or more networks (e.g., home network 100) and/or locations (e.g., location 101),

In an example embodiment of the disclosure, a grouping of networks may comprise one or more network, network managers and/or locations. The grouping may be programmable and/or configurable. For example, one more networks may be defined, one or more network managers may be assigned per network and/or associated with one or more devices with a network and/or a network manager. In this regard, the information may be shared between the different networks, network managers and/or devices assigned to the different networks and/or network managers. For example, information gathered on one network (e.g., by a network device, through an occurrence of a condition, event, an alarm, and/or other predefined and/or preconfigured condition) may cause the information to be communicated on the same and/or another associated network. In this regard, the information may trigger a condition, an alarm, an occurrence of an event and/or any other predefined and/or preconfigured condition (e.g., operation of a device, network element) on the same and/or another associated network.

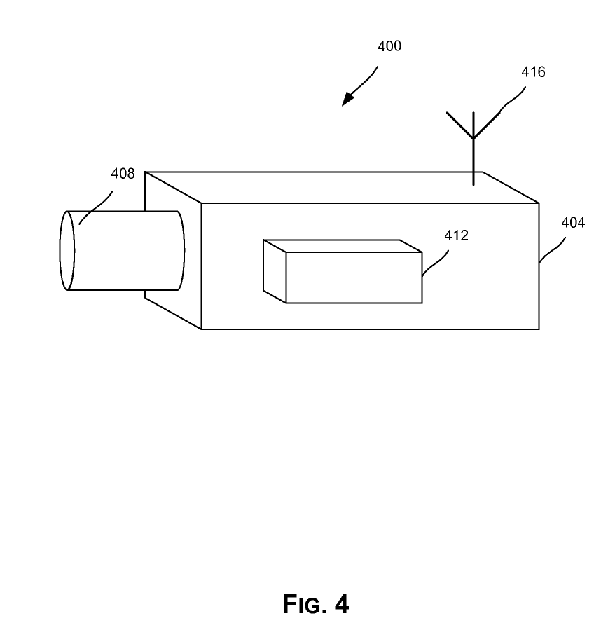

In an example embodiment of the disclosure, one or more home network elements (e.g., home network elements 120a-120o) may be configured to provide enhanced functionality, especially in the context of the home network provided by home network managers (e.g., the home network manager 110). For example, in addition to utilizing a typical video gateway, an enhanced video gateway device may be utilized, such as to provide enhanced and/or remote gateway monitoring, activation, communication, control and/or other functionality in a home network (e.g., the home network 100). An example video gateway device is depicted in and/or described with respect to FIG. 4.

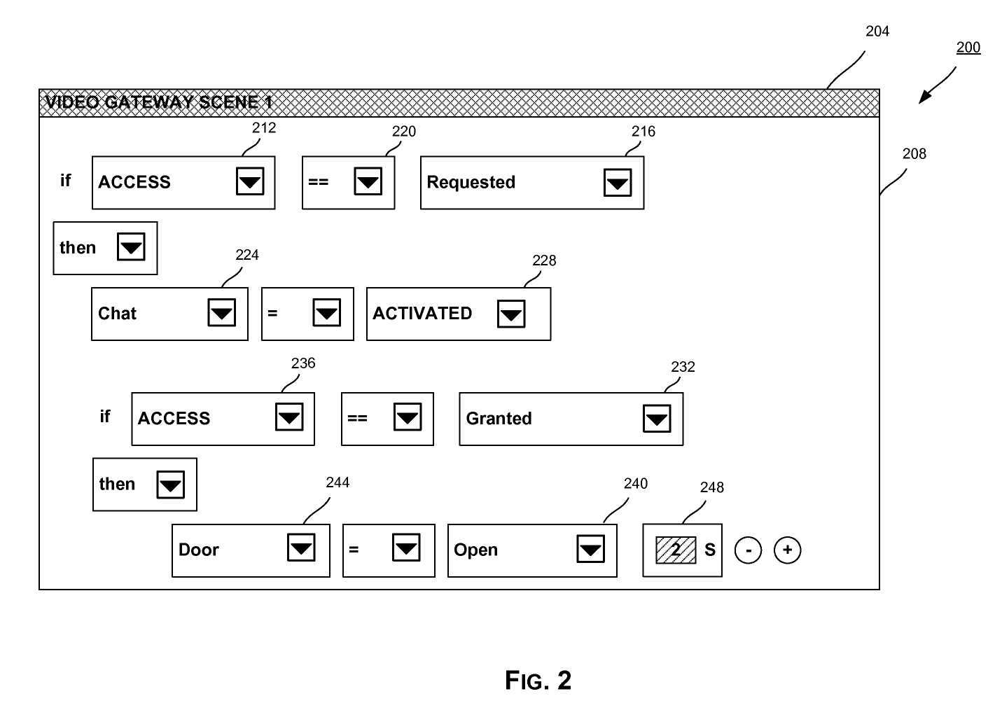

FIG. 2 illustrates an example programmable gateway scene or programmable scene 200 for use with the home network manager 110 of FIG. 1. In some embodiments, the home network manager 110 of FIG. 1 may provide an interface 204 that allows a user to program a desirable scene 208. Particularly, the scene may let a user program a plurality of complicated functions between multiple devices included in the home network 100. For example, a scene may be initiated by weather condition, a series of intuitive timers or various sensor/module states. A scene may also include a group of commands sent to a user-defined group of devices. In some embodiments, a command to program and/or control a blind 120d and a lighting fixture 120e such as “open the blinds 50%; and set the lights to 30% brightness” may be entered for a particular room to open one or more blinds 120d at 50% brightness and to set lights 120e to 30% brightness. In some embodiments, one or more scenes may be initiated, for example, by user-defined actions such as “run the scene if the motion sensor is tripped or the room temperature exceeds 27 degrees.” In another embodiment, one or more scenes may be initiated within the programmable scene 200, for example, by defining one or more timers, such as “run the scene each day at 8:30 am, and on Monday at 12:15 pm.”

In some embodiments, the programmable scene 200 provides a plurality of alternatives to create and configure a scene. For example, in one embodiment, the programmable scene 200 may provide a graphical, block interface to create and configure a scene. Scenes created with the graphical block interface may be intuitive to build. Alternatively, the programmable scene 200 may provide a programming environment in which a user may enter programming instructions, for example, based on a LUA engine, and thus may require some basic programming skills. In such embodiments, when creating scenes based on LUA using LUA scripting language, a user may select an action and characteristics or properties of individual devices from a context menu. For example, in some embodiments, scenes may be added within the programmable scene 200 via programming and/or “if” and “then” logic compositions. In such embodiments, a user may add a scene for activating a sprinkler (not shown) if an exterior humidity drops below 0% for five hours. Thus, in some embodiments, a user may select a predefined parameter and compare the predefined parameter with a threshold above which an action is to be taken, for a predetermined amount of time, for example.

In the embodiment shown in FIG. 2, the programmable scene 200 is titled “VIDEO GATEWAY SCENE 1.” In the programmable scene 200, the predefined parameter is ACCESS selected in box 212, and the threshold may be defined in box 216. In this embodiment, the comparison is equality in box 220. For example, if the threshold is set to Requested, and if a door entry (ACCESS) to the location 101 of FIG. 1 equals to (or has been) “requested” by a person, an action (as defined in box 224) is to be taken place. In this embodiment, the action to be taken is to turn on (in box 228) an action, which is a chat session (in box 224). For example, when the door entry (ACCESS) has been requested, the home network manager 110 may connect locally or remotely to a home network element (e.g. 120a-120o) that has been registered with the home network manager 110 of FIG. 1. In this embodiment, a chat is commenced. The chat may be audio, or video, depending on application. In the embodiments where audio chat is commenced, the network elements 120a-120o may also include a microphone (not shown) or an audio device (not shown) to conduct the audio chat session. In the embodiments where video chat is preferred, the home network manager 110 of FIG. 1 may commence a video chat session via a coupled video gateway device similar to the video gateway device 120o of FIG. 1. In such cases, the video gateway device 120o performs functions of a live web cam. A user of the home network 100 of FIG. 1, may communicate with the person in the audio or video chat session via a home network element (e.g. 120a-120o) that has been registered with the home network manager 110 of FIG. 1, for example the TV 120a, the computer 120b, the desktop 120c, the tablet 120j, or the mobile phone 120k.

Referring back to FIG. 2, after the chat session has been activated, the user of the home network 100 of FIG. 1 may grant or deny access to the location 101 of FIG. 1. For example, when the user grants as defined in box 232 access as defined in box 236 to the location 101, and activates one or more of the home network elements 120a-120o, such as, for example, the security device 120i to open (as defined in box 240) a door (as defined in box 244). In some embodiments, the door as defined in box 244 may not be the same door entry at which the person is requesting entry. In other embodiments, the door as defined in box 244 may be the same door entry at which the person is requesting entry. In some embodiments, the ACCESS Granted action and the Door Open action may also be time-stamped, and identity of the user that grants the access and the person that requested the entry may also be logged. In some embodiments, the audio or video chat may also be recorded. Thus, any home network element (e.g. 120a-120o) that has been registered with the home network manager 110 of FIG. 1 can grant or deny access to the location 101, even when the user may be connected to the home network manager 110 remotely via the Internet.

In the embodiment shown in FIG. 2, the door as defined in box 244 may be opened as defined in box 240 for an amount of time as defined in box 248, for example, 2 seconds. In some embodiments, the amount of time as defined in box 248 can be fixed. After the amount of time as defined in box 248 has elapsed, the door may be closed automatically. In other embodiments, after the amount of time as defined in box 248 has elapsed, the home network manager 110 of FIG. 1 may also monitored if the door is closed within a predefined amount of time. The home network manager 110 may activate a predefined security breached action when the door is not closed with the predefined amount of time. For example, if the home network manager 110 determines that the door is not closed within the predefined amount of time, the home network manager 110 may set off an alarm, for example, the security device 120i of FIG. 1. In other embodiments, the home network manager 110 may continue to monitor the entry after the door has been opened via the video gateway device 120o, or the intelligent motion sensor 120l of FIG. 1, for example, for additional entry of the location 101 by a person other than the person that originally requested the entry.

In an example embodiment of the disclosure, the monitoring, controlling and/or management functions of a video gateway device (e.g., video gateway device 400) may be performed though a local, remote and/or cloud-based interface.

In an example embodiment of the disclosure, a video gateway device (e.g., video gateway device 400) may be responsive and/or activated though one or more internal and/or external sensors. For example, a video gateway device (e.g., video gateway device 400) may be responsive and/or activated in response to an input signal from a motion detector indicative of motion detected at a location associated with the video gateway device (e.g., video gateway device 400). In an example embodiment of the disclosure, a video gateway device (e.g., video gateway device 400) may automatically adjust its functions and operations based on the time of day (e.g., night, day).

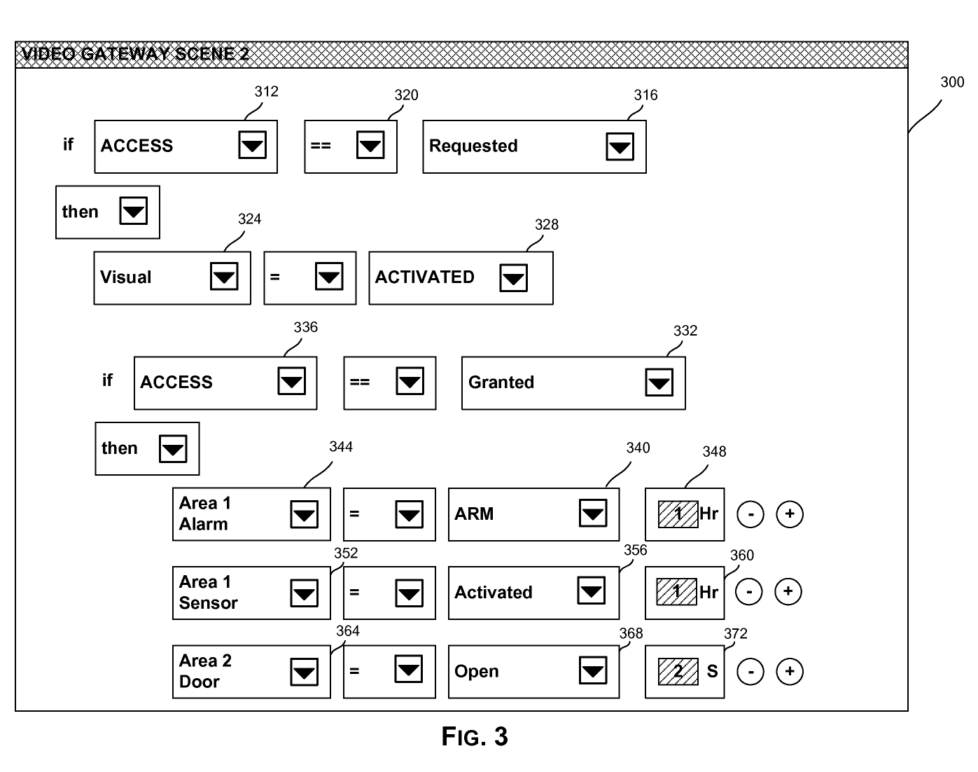

Similarly, FIG. 3 shows a second exemplary programmable gateway scene or programmable scene 300. The second exemplary programmable scene 300 is titled “VIDEO GATEWAY SCENE 2.” In the second exemplary programmable scene 300, which is similar to VIDEO GATEWAY SCENE 1 of FIG. 2, the predefined parameter is ACCESS selected in box 312, and the threshold may be defined in box 316. In this embodiment, the comparison is equality in box 320. For example, if the threshold is set to Requested, and if a door entry (ACCESS) to the location 101 of FIG. 1 equals to (or has been) “requested” by a person, an action (as defined in box 324) is to be taken place. In this embodiment, the action to be taken is to turn on (in box 328) an action, which is a visual session (in box 324). For example, when the door entry (ACCESS) has been requested, the home network manager 110 may connect locally or remotely to a home network element (e.g. 120a-120o) that has been registered with the home network manager 110 of FIG. 1. In this embodiment, a visual session is commenced. In some embodiments, when a visual session is commenced, the network elements 120a-120o may also use a coupled video gateway device similar to the video gateway device 120o of FIG. 1 for visual purposes only. That is, audio may not be present. In such cases, the video gateway device 120o may perform functions of still-photography camera. A user of the home network 100 of FIG. 1, may communicate with the person in the visual session via a home network element (e.g. 120a-120o) that has been registered with the home network manager 110 of FIG. 1, for example the TV 120a, the computer 120b, the desktop 120c, the tablet 120j, or the mobile phone 120k. The camera may comprise a still-image camera, a video camera, an internet camera and/or another image/video capturing device. The capture may be accessed locally and/or remotely. In another example embodiment, the capture may be recorded or may be accessible live.

Referring back to FIG. 3, after the visual session has been activated, the user of the home network 100 of FIG. 1 may grant or deny access to the location 101 of FIG. 1 based on the visual session. For example, when the user grants as defined in box 332 access as defined in box 336 to the location 101, and activates one or more of the home network elements 120a-120o, such as, for example, the security device 120i to arm the alarm (security device 120i) and the intelligent motion sensor 120l to monitor a predefined area before opening the requested door.

In the embodiment shown in FIG. 3, the alarm 120i of an area (AREA 1) as defined in box 344 may be armed as defined in box 340 for an amount of time as defined in box 348, for example, 1 hour. In some embodiments, the amount of time as defined in box 348 can be fixed. Similarly, the sensor 120l as defined in box 352 is also activated as defined in box 356 for an amount of time as defined in box 360, for example, 1 hour. In some embodiments, if equipped in area 1, a video gateway device 120o associated with area 1 may also be activated to monitor entry into and/or exit from area 1. After the alarm and the sensor in area 1 have been activated, a door in area 2 as defined in box 364 is opened as defined in box 368 for an amount of time as defined in box 372, for example, 2 seconds. In such a case, the user controls the video gateway device 120's visual session where and for how long the person requesting the entry can go. In the example shown, the person is permitted to go to area 2, but not area 1. Thus, the home network manager 110 arms the user with alarm and sensor, and optionally another video gateway device to monitor entry into the area 1. After the amount of time as defined in box 348 has elapsed, the area 2 door may be closed automatically. Thus, the user can use the home network manager 110 to allow access into area 1 for 1 hour.

FIG. 4 illustrates a video gateway device 400 according to one embodiment of the present invention. The video gateway device 400 may be organically designed and/or configured to communicate an video, audio, and/or visual message and/or signal, such as, for example, to a home network manager (e.g., home network manager 110 of FIG. 1) and/or one or more network elements or device(s) (e.g., network elements 120a-102o) directly, via another device and/or via a home network manager (e.g., home network manager 110 of FIG. 1.) In some embodiments, the video gateway device 400 may be entirely or substantially enclosed within a concealing shell (not shown) to conceal the video gateway device 400.

In some embodiments, the video gateway device 400 may be mounted in any position, for example, at a gateway, an entry point, or a door. Further, the video gateway device 400 may include, for example, a housing 404 and a lens 408, a microphone 412, and an antenna 416. In some embodiments, the lens 408 may be a zoom able lens with variable focal length to focus on a subject, for example, the person requesting entry. In other embodiments, the lens 408 may be fixed focal length lens.

The video gateway device 400 may include suitable communication circuitry, interfaces, logic, and/or code for implementing various aspects of the present disclosure. More specifically, the video gateway device 400 may include the optional external antenna 416 to communicate with, for example a network device (e.g., network elements 120a-120o), a home network manager (e.g., the home network manager 110 of FIG. 1) and/or other devices. In other embodiments, the video gateway device 400 may communicates with a network device, a home network manager and/or other devices using an internal antenna (not shown). The video gateway device 400 may include an optional microphone 412 to perform functions of a live web cam. In other embodiments, the microphone 412 may be embedded with the housing 404. Further, although shown as being an external antenna, in other embodiments, the video gateway device 400 may communicate with the home network manage 110 of FIG. 1 via cables or internal antenna. In some embodiments, the housing 404 may be waterproof to allow the video gateway device 400 to be used outdoors. In some embodiments, the video gateway device 400 or the housing 404 may also include one or more access ports (not shown) to perform various functions. For example, the access ports may include a power port for receiving external power, a data port such as a USB port for receiving data, and a programming port for receiving a programming interface.

In some embodiments, the video gateway device 400 may also include a processor (not shown) to perform various processing functions. For example, in some embodiments, the processor may activate the video gateway device 400 when an entry has been requested. The processor may also control an actuation or rotating device (not shown) when the video gateway device 400 has been activated. In some embodiments, the actuation device may rotate and tilt the video gateway device 400 such that the lens 408 may point to focus on a subject. In this regard, the processor may also include facial and/or speech recognition modules (not shown) to locate the subject. Further, the processor may also receive programming instructions received through the programming interface to adjust and/or modify operations of the lens 408, and/or video gateway device 400. As discussed above with respect to FIG. 3, the processor may also activate one or more video gateway devices 400 such that the one or more video gateway devices 400 may monitor entry to different areas of the location 101 of FIG. 1. Further, the processor may also activate one or more sensors, for example, the security sensors 120l, in the different areas before access is granted to the location 101. In some embodiments, the processor may time-stamp and/or log one or more of the request entries and their corresponding actions.

In some embodiments, the video gateway device 400 may also include other display interfaces (not shown) to provide the video gateway device 400 with interactive capabilities. For example, the display interfaces may include a keypad (not shown) to receive passwords and/or operational instructions, such as, programming instructions. The display interfaces may also include a graphical and/or text display to display statuses of requests. The display interfaces may also include other visual indicators to direct attention from a person requesting entry to the location 101, and/or to allow a user of the home network to communicate visually or audibly with the person requesting entry.

In some embodiments, the video gateway device 400 may also include a communication module (not shown) to communicate with the home network manager 110 of FIG. 1, and/or other home network elements (for example, 120a-120o). For example, as discussed with respect to FIG. 2, the communication module may receive an access granting signal from the user, and communicate the signal to the processor for further processing. In such a case, the processor may determine the signal is authentic and thus activate a door opening mechanism to open a door. In some embodiments, the communication module may also communicate, relay, and/or activate one or more video gateway devices 400 in a predefined area, when an access has been granted, via the antenna 416, using wireless communication protocols, such as, for example, the z-wave communication protocol.

The disclosure is not limited to any particular scene or sequence of events that may be activated and/or initiated by operation and/or functionality of the video gateway device. It is to be understood that the type of devices to be controlled, the setting on the devices and/or any scenes may be preprogrammed, preconfigured and/or otherwise customized based on the desired outcome.

The video gateway device 400 may comprise one or more buttons (and/or other interfaces) (not shown) either inside or outside of the housing 404 for providing other basic functionalities. One or more functions of the video gateway device 400 may comprise range testing (e.g., whether the video gateway device 400 is within a home network if communication is wireless), connecting to a home network (e.g., paring between a video gateway device 400 and a home network through, for example, a network manager) and/or temper prevention.

In an example embodiment of the disclosure the one or more buttons may be located inside of the housing 404, such that, for example, when the video gateway device 400 is tampered with (e.g., casing is opened) the button may, for example, become depressed. In this regard, the video gateway device 400 may generate a temper alarm condition. The condition may be communicated to the home network (e.g., home network 100), to other devices and/or a home network manager (e.g., home network manager 110).

The video gateway device 400 may comprise one or more visual and/or audible indicators (e.g., LED(s), speaker(s), and/or other interfaces) (not shown) either inside or outside of the housing 404. The one or more visual and/or audible indicators may be used in connection with, for example, providing visual and/or audible cues indicative of, for example, the status of the video gateway device 400 (e.g., within home network range, connected to a home network, in paring mode) and/or operation the one or more buttons.

The video gateway device 400 may be configured for operation on a home network (e.g., home network 100 as depicted in and/or described with respect to FIG. 1), such that, the video gateway device 400 may be utilized as a home network element. In this regard, the video gateway device 400 may be configured to interact, for example, in a home network (e.g., home network 100 as depicted in and/or described with respect to FIG. 1) with, for example, a home network manager (e.g., home network manager 110).

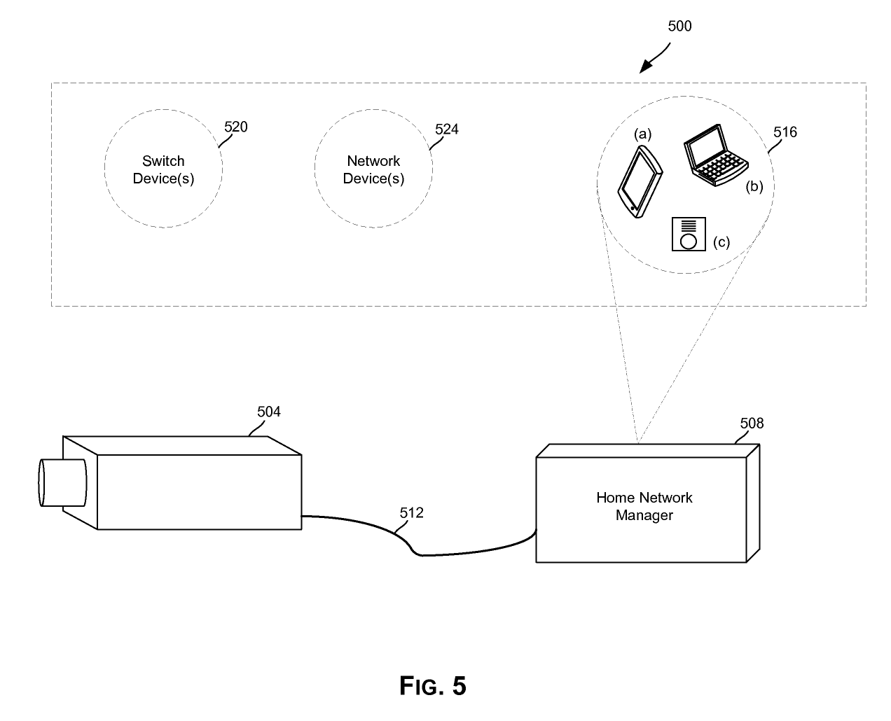

In an example embodiment of the disclosure, the video gateway device 400 may comprise one or more input/output (“I/O”) interfaces. The I/O interface may comprise suitable logic, circuitry, interfaces, and/or code that may be operable to enable user interactions with the video gateway device 400 through interfaces, such as, for example, interfaces provided by the example interface device(s) 516(a)-(c), as show in, for example, FIG. 5. The I/O interface may obtain input from user(s) of the video gateway device 400 and/or provide output to the user(s). The I/O interface may support various types of inputs and/or outputs, including, for example, video, audio, and/or textual. In this regard, dedicated I/O devices and/or components, external to or integrated within the video gateway device 400, may be utilized for inputting and/or outputting data during operations of the I/O interface. Exemplary (external or integrated) I/O devices may comprise displays, mice, keyboards, touchscreens, voice input interfaces, and other input/output interfaces or devices.

The example interface device(s) 516a-c may, for example, provide a graphical user interface (GUI) for controlling the operation of one or more video gateway devices (e.g., video gateway device 400) and/or controlling and/or monitoring one or more control devices (e.g., switch device(s) 520 and network device(s) 524) associated with the one or more of the one or more video gateway devices.

In an example embodiment of the disclosure, the video gateway device 400 may be operable to communicate with a network manager (e.g., home network manager 110). The video gateway device 400 may communicate, to the network manager, information and/or data relating to, for example, status of the video gateway device 400, one or more video gateway devices may be linked, controlled and/or monitored by and/or connected to another video gateway device. The communications may comprise status information, predefined and/or predetermined conditions and/or any other information that may be relevant to the operation of one or more video gateway devices 400 of a home network. The status and/or predefined and/or predetermined conditions may comprise status and/or alarm conditions associated with operation of one or more video gateway device s.

In an example embodiment of the disclosure, the video gateway device 400 may incorporate a wireless range tester (not shown) that may be operable to, for example, determine whether the video gateway device 400 is within a range of a home network manager (e.g., home network manager 110) and/or other network element. In this regard, the video gateway device 400 may be operable to generate an alarm condition when the video gateway device 400 is not within a range of any home network manager (e.g., home network manager 110) and/or other network element and/or when the video gateway device 400 that, for example, was previously within the range of a (e.g., home network manager 110) and/or other network element, is now outside of that range. In an example embodiment of the disclosure, the alarm condition may active one or more alarm indicators to generate an alarm condition by, for example, generating an audible and/or a visual alarm.

In another example embodiment of the disclosure, wireless range tester may indicate whether the video gateway device 400 is in range, is in an intermediate range and/or is out of range of a home network manager, if the video gateway device 400 communicates wirelessly. The in range indication may, for example, be associated with a condition where the video gateway device 400 may establish a direct connection with a home network manager (e.g., home network manager 110) and whether or not a direct communication is desirable (e.g., the video gateway device 400 may, for example, communicate with the home network manager utilizing other network elements although a direct communication would be possible). The in an intermediate range condition may, for example, be associated with a condition where the video gateway device 400 may not establish a direct connection with a home network manager (e.g., the home network manager 110) but may establish an indirect communication with the home network manager (e.g., through other network elements). The out of range indication may, for example be associated with a condition where the video gateway device 400 may not be able to establish either a direct and/or in direct communication with a home network manager (e.g., the home network manager 110).

In an example embodiment of the disclosure, the video gateway device 400 may indicate whether the video gateway device 400 is in range (e.g., direct, indirect) and/or out of range through one or more audio and/or visual indicators. The indicators may be, for example, integrated with and/or external to the video gateway device 400. For example, the video gateway device 400 may comprise an external visual indicator (e.g., LED, RGB, RGBW light) that may be operable to display the status of the video gateway device 400 with respect to the range through different colors and/or illumination schemes. For example, a visual indicator may display a different color depending on the in-range status (e.g., one color may indicate that the video gateway device 400 is in a direct range, a second color may indicate that the video gateway device 400 is in indirect range and/or a third color may indicate that the video gateway device 400 is out of range). In another example, the visual indicator may blink at different frequencies, illuminate without blinking and/or be operable to display different illumination schemes depending on the in-range status of the video gateway device.

In another example embodiment of the disclosure, the video gateway device 400 may activate other light sources (e.g., connected on one or more output and/or hybrid input/output ports of the video gateway device 400 and/or other light sources connected on the network).

In an example embodiment of the disclosure, the video gateway device 400 may comprise other suitable circuitry, interfaces, logic, and/or code for implementing various aspects of the present disclosure. For example, the video gateway device 400 may comprise a memory and/or a processor.

The memory may store, for example, configuration data, which may comprise parameters and/or code, comprising software and/or firmware. The memory may comprise different memory technologies, including, for example, read-only memory (ROM), electrically erasable programmable ROM (EEPROM), random access memory (RAM), low latency nonvolatile memory, flash memory, solid-state drive (SSD), field-programmable gate array (FPGA), and/or other suitable electronic data storage capable of storing data, code and/or other information.

In an example embodiment of the disclosure, the video gateway device 400 may be operable to receive software and/or firmware updates. For example, the video gateway device 400 may receive software and/or firmware updates from a network manager (e.g., the home network manager 110). In an example embodiment of the disclosure the software and/or hardware updates may be received, processed and/or installed automatically and/or manually. For example, the process may be completely automatic (e.g., a network manager may send an update to the video gateway device 400), and/or semi-automatic (e.g., an update may be initiated by a user through, for example, a network manager, and may, for example, be processed by the video gateway device 400 automatically).

The processor may comprise suitable circuitry, interfaces, logic, and/or code that may be operable to process data, and/or control and/or manage components, operations and/or functions of the video gateway device 400, and/or tasks performed therein. In this regard, the processor may configure and/or control operations of various components and/or subsystems of the video gateway device 400, such as, for example, the memory, the communication subsystem (e.g., for communicating with, for example, the home network manager 110) by utilizing, one or more control signals.

FIG. 5 illustrates example operation 500 of a video gateway device 504 with an example home network manager 508. The video gateway device 504 may comprise the video gateway device 400 of FIG. 4, for example. The home network manager 508 may comprise the home network manager 110 of FIG. 1, for example. In the example embodiment shown, the video gateway device 504 may be wired to the home network manager 508 to communicate with the home network manager 508 via a communication link 512. In other embodiments, the video gateway device 504 may communicate wirelessly with the home network manager 508, such as, for example, a z-wave communication protocol

For example, the home network manager 508 may be programmed to perform one or more actions, in response to receiving a signal from the video gateway device 504. In some embodiments, statuses of the video gateway device 504 may also be monitored through one or more interface devices 516, for example, a laptop 516a, a mobile device 516b, or a security device 516c. Also, the home network manager 508 may also be programmed to activate certain devices such as switch devices 520 and network devices 524. In some embodiments, the switch devices 520 may include an actuator (not shown) that opens a door (not shown). In some embodiments, the network devices 524 may include telephony communication devices (not shown) that is programmed to place one or more telephonic or internet messages to a pre-defined recipient, such as, for example, an emergency number.

The disclosure is not limited to any particular type of a communication link. For example, the video gateway device 504 may be implemented to support, for example one or more wireless and/or wired links, protocols and/or connections. For example, wireless links, protocols and/or connections, may comprise, for example, WPAN (e.g., Bluetooth or ZigBee) and/or WLAN (WiFi/802.11) protocols and/or any other wireless links, protocols and/or connections suitable for implementation consistent with the disclosure. Wired links, protocols and/or connections may comprise, for example, Ethernet, Universal Serial Bus (USB), and/or any other wired links, protocols and/or connections suitable for implementation consistent with the disclosure. While not shown in FIG. 2, to support communication with other elements or systems, such as the home network manager 508, the video gateway device 504 may incorporate a communication transceiver (e.g., a Z-Wave transceiver) and/or related processing resources for allowing use of the video gateway device 504.

In an example embodiment of the disclosure, the video gateway device 504 may provide wired and/or wireless interfaces that may enable one or more network devices to connect to a home network (e.g., home network 100) and/or home network manager (e.g., home network manager 508). For example, if the network manager provides connectivity of various devices to a home network, for example, based on a Z-Wave protocol, the video gateway device 504 may, for example, contain suitable circuitry, interfaces, logic, and/or code that may enable a particular device that, for example, may not be compatible with the example Z-Wave protocol (and/or any other particular protocol that the network manager supports) to connect to the network manager and/or the home network.

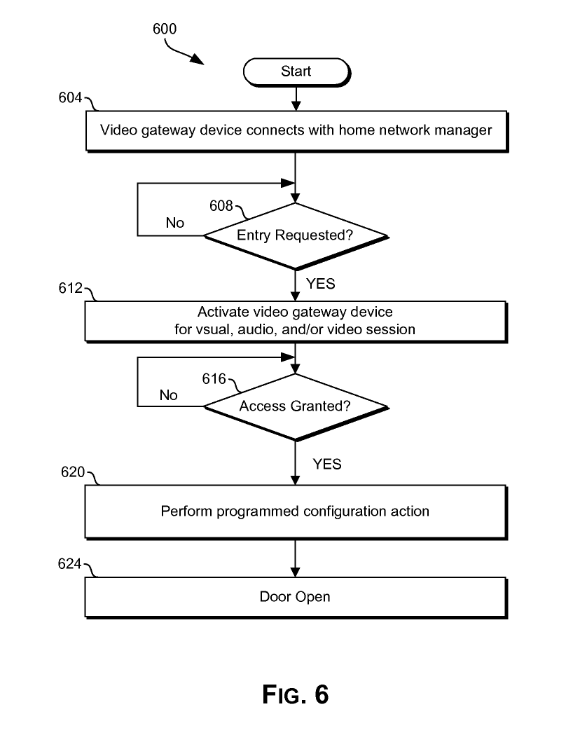

FIG. 6 illustrates an example flow chart 600 of a method for an example process of operation of a video gateway device. In the example step 604, after a video gateway device (e.g., the video gateway device 400) has been placed in a desirable location, the video gateway device may be programmed to connect with a home network manager (e.g., the home network manager 110). In the example step 608, the home network manager may monitor for an entry request at step 608, for example, by a person. If the home network manager determines that an entry request has been made, for example, for entry in area 1 through door 1 (not shown), the home network manager may activate a video gateway device to begin a visual, audio, and/or video session, as described above with respect to FIG. 2 and FIG. 3. For example, the home network manager may activate the video gateway device to start a video chat between the requesting person via the video gateway device and a user using the TV 120a, the computer 120b, the desktop 120c, the tablet 120j, or the mobile phone 120k of FIG. 1.

The user may deny entry as determined in step 616. If the user grants entry to the request as determined in step 616, the home network manager may optionally perform programmed configuration action in step 620. For example, as described above with respect to FIG. 2 and FIG. 3, the home network manager may secure a specific area that the user does not want the requesting person to enter, for example, area 2, by arming another video gateway device, motion sensor, and alarm the specific area. The home network manager may then open the request door in step 624.

Other implementations may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for a video gateway device.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A programmable video gateway device for use with a gateway and a home network manager having a plurality of associated network elements, the gateway has a plurality of user-programmable actions, the device comprising:
a processor configurable to control the plurality of user-programmable actions;
a camera module configurable to be controllable to capture an image, wherein the camera module is configurable to be controlled via at least one of the home network manager and the processor;
an interface configurable to receive one or more entry requests, wherein the interface is configurable to receive commands from a user to program one or more of the plurality of user-programmable actions to respond to the received one or more entry requests via the processor.

2. A programmable video gateway device of claim 1, further comprising an antenna configurable to communicate one or more of the plurality of user-programmable actions to one of the home network manager and the associated network elements.

3. A programmable video gateway device of claim 1, wherein the interface comprises a plurality of light emitting diodes (LEDs).

4. A programmable video gateway device of claim 3, wherein at least one of the LEDs is configurable to illuminate in a pre-defined color in response to one or more of the received entry requests, wherein the pre-defined color is different for as between at least two of the received entry requests.

5. A programmable video gateway device of claim 1, wherein the plurality of user-programmable actions includes one or more actions configurable to be activated at one or more of the associated network elements.

6. A programmable video gateway device of claim 1, further comprising a communication module configured to communicate one or more of the received entry requests to one of the home network manager and the plurality of associated network elements.

7. A programmable video gateway device of claim 1, wherein when the interface receives a correct entry request, at least one of the home network manager and the processor is further configured to activate one of the plurality of user-programmable actions via at least one of the gateway and the programmable video gateway device.

8. A programmable video gateway system comprising:
a gateway configurable to perform a plurality of user-programmable functions;
a plurality of associated network elements including a gateway device installed at the gateway, said gateway device having a plurality of user-programmable functions, wherein the gateway device has a processor that controls the plurality of user-programmable functions, a camera module controllable to record an image, and a device interface that receives one or more entry requests; and
a home network manager having a manager interface configured to enable a user to program the plurality of user-programmable functions to respond to one or more of the received entry requests via the processor.

9. A programmable video gateway system of claim 8, and wherein the gateway device has an antenna configurable to communicate one or more of the one or more entry requests to one of the home network manager and the associated network elements.

10. A programmable video gateway system of claim 8, and wherein the device interface comprises a plurality of light emitting diodes (LEDs).

11. A programmable video gateway system of claim 10, and wherein one or more of the plurality of LEDs is configurable to illuminate in a pre-defined color in response to one or more of the received entry requests, wherein the pre-defined color is different for as between at least two of the received entry requests.

12. A programmable video gateway system of claim 8, and wherein the plurality of user-programmable functions include actions activable at one or more of the associated network elements.

13. A programmable video gateway system of claim 10, and wherein one the plurality of use-programmable functions includes opening the gateway.

14. A programmable video gateway system of claim 8, and wherein the gateway device has a communication module configured to communicate the received entry requests to at least one of the home network manager and the plurality of associated network elements.

15. A programmable video gateway system of claim 8, and wherein when the device interface receives a correct entry request, at least one of the home network manager and the processor configured to activate one of the plurality of user-programmable functions of the gateway.

16. A method of activating a gateway via a home network manager having one or more associated network elements, wherein one or more of the associated network elements is a gateway device having a processor that controls one or more of user-programmable actions, a camera module controllable to record an image, and a device interface that receives one or more entry requests, the method comprising:
enabling via the device interface the gateway to receive one or more of the one or more of user-programmable actions to respond to one or more of the received entry requests;
recording an image with the camera module;
receiving one of the one or more entry requests at the gateway device; and
determining one or more of the one or more of user-programmable actions based on one or more of the received entry requests.

17. A method as claimed in claim 16, wherein the gateway device has an antenna that communicates one or more of the one or more entry requests to one of the home network manager and the associated network elements.

18. A method as claimed in claim 16, and wherein the device interface comprises a plurality of light emitting diodes (LEDs).

19. A method as claimed in claim 16, further comprising illuminating at least one of the LEDs in different colors in response to different received entry requests.

20. A method as claimed in claim 13, and wherein the gateway device has a communication module, the method further comprising communicating, via the communication module, one or more of the one or more received entry requests to one of the home network manager and the plurality of associated network elements.
